(19) United States
(12) Patent Application Publication
(10) Pub. No.: US 2025/0134135 A1
(43) Pub. Date: May 1, 2025

(54) EXTRUDED PUFFED HIGH PROTEIN FOOD PIECES AND METHODS OF MAKING

(71) Applicant: GENERAL MILLS, INC., Minneapolis, MN (US)

(72) Inventors: Claire RANDOLPH, Robbinsdale, MN (US); Robert Joseph HARRISON, Nowthen, MN (US); Jeffrey T. HUBER, Robbinsdale, MN (US); Michelle MANDERFELD, Plymouth, MN (US); Sara ROSENE, New Hope, MN (US); Goeran WALTHER, Plymouth, MN (US)

(21) Appl. No.: 18/837,280

(22) PCT Filed: Feb. 14, 2023
(86) PCT No.: PCT/US2023/013004

§ 371 Date: Aug. 9, 2024

Related U.S. Application Data
(60) Provisional application No. 63/309,825, filed on Feb. 14, 2022.

(51) Int. Cl. A23J 3/26; A23J 3/10; A23J 3/16; A23P 30/20; A23P 30/34

(52) U.S. Cl. CPC A23J 3/265; A23J 3/10; A23J 3/16; A23P 30/20; A23P 30/34

(57) ABSTRACT

The present disclosure relates to low density, high protein, ready-to-eat food pieces, compositions including such food pieces, and methods of making such food pieces. The food pieces include at least 70% by dry weight protein, where the protein ingredients include a base protein blend that makes up at least 60% by weight of the protein ingredients. The base protein blend includes sodium caseinate and one or more of legume protein isolate, legume protein concentrate, milk protein isolate, or milk protein concentrate.

### CROSS-REFERENCE TO RELATED APPLICATIONS

This application claims the benefit of U.S. Patent Application Ser. No. 63/309,825 entitled “Extruded Puffed High Protein Food Pieces and Methods of Making” filed Feb. 14, 2022, pending. The entire content of this application is incorporated herein by reference.

### TECHNOLOGY

The present disclosure generally relates to an extruded protein product and methods of making such a product.

### BACKGROUND

High protein food products have found popularity among consumers as a way to eat nutritionally dense foods. Consumers want diverse ways to get increased protein into their diets. Thus, there is a need for new high protein food products to satisfy the increasing consumer desire for protein.

### SUMMARY

Low density, high protein, ready-to-eat food pieces and methods of making such food pieces are provided herein.

A low density, high protein, ready-to-eat (RTE) food piece is provided herein. Such a food piece can have a moisture content of about 1% to about 7%. A food piece includes protein ingredients, where the protein ingredients include a base protein blend that comprises at least 60% by dry weight of the protein ingredients. The base protein blend consists of sodium caseinate (Na Cas) in an amount of about 10% to about 60% by dry weight of the protein ingredients; and legume protein isolate (LPI), legume protein concentrate (LPC), milk protein isolate (MPI), milk protein concentrate (MPC), or a combination thereof in an amount of about 20% to about 80% by dry weight of the protein ingredients.

In some embodiments, soy protein isolate (SPI) can be included in an amount of up to 55% by dry weight of the protein ingredients. In some embodiments, milk protein isolate (MPI) can be included in an amount of up to 50% or up to 55% by dry weight of the protein ingredients.

In some embodiments, a food piece can include Na Cas in an amount of 10% to about 40% by dry weight of the protein ingredients, MPI, MPC, or a combination thereof in an amount of 20% to 50% by dry weight of the protein ingredients, and SPI, SPC, calcium caseinate (Ca Cas), or a combination thereof in an amount of about 20% to 50% by dry weight of the protein ingredients. In some embodiments, a food piece can include Na Cas in an amount of 10% to about 40% by dry weight of the protein ingredients, MPI, MPC, or a combination thereof in an amount of 25% to 45% by dry weight of the protein ingredients, and SPI, SPC, Ca Cas, or a combination thereof in an amount of about 25% to 45% by dry weight of the protein ingredients.

In some embodiments, a food piece can include calcium carbonate in an amount of about 0.1% to 4% by dry weight of the food piece.

In some embodiments, a food piece can include an oil (e.g., canola oil or corn oil) in an amount of about 0.1% to about 5% by dry weight of the food piece.

In some embodiments, a food piece can include one or a combination of additional protein ingredients in an amount of up to 40% by dry weight of the protein ingredients.

In some embodiments, a food piece can include an additional ingredient in an amount of up to 15% by dry weight of the food piece.

In some embodiments, ingredients derived from grains can be included in a food piece in an amount of less than 15% by dry weight. In some embodiments, a food piece can contain no ingredients derived from grains.

In some embodiments, a food piece can contain less than 5% by dry weight carbohydrate. In some embodiments, a food piece can contain no added carbohydrates.

A method of making a low density, high protein, RTE food piece is also provided. Such a method can include combining ingredients under extrusion conditions to make a composition having a protein content of at least 70% by dry weight of the composition; forming and puffing the composition by directing the composition through a die opening to make a puffed piece; and

drying the puffed piece to a moisture content of about 1% to about 7% to produce the food piece. The ingredients in the composition include water in an amount of about 8% to about 20% by weight of the composition, and protein ingredients including a base protein blend comprising at least 60% by dry weight of the protein ingredients, where the base protein blend consists of Na Cas in an amount of about 10% to about 60% by dry weight of the protein ingredients; and LPI, LPC, MPI, MPC, or any combination thereof in an amount of about 20% to about 80% by dry weight of the protein ingredients. The extrusion conditions include low shear, and a barrel temperature of about 160° F. to about 260° F., or about 170° F. to about 250° F.

In some embodiments, extrusion conditions can include a twin screw extruder with 2 reverse or high shear elements.

In some embodiments, extrusion conditions can include a die pressure of about 550 psi to about 1800 psi, or from about 1000 psi to about 1500 psi.

In some embodiments, extrusion conditions can include specific mechanical energy (SME) of about 80 W*h/kg to about 140 W*h/kg, or from about 85 W*h/kg to about 125 W*h/kg.

In some embodiments, extrusion conditions can include a die temperature of about 200° F. to about 280° F., or from about 220° F. to about 280° F.

Also provided herein are packaged food products comprising food pieces disclosed herein. A packaged food product can contain food pieces made according to any method provided herein.

These and various other features and advantages will be apparent from a reading of the following detailed description.

### BRIEF DESCRIPTION OF THE DRAWINGS

FIG. 1 shows pictures of embodiments (Variations 2 and 6 from Example 1) that are particularly smooth, even, and spherical in shape, suggesting little to no inhibition of radial expansion from the die.

FIG. 2 shows pictures of embodiments (Variations 1, 3, 4, and 7 from Example 1) that have a slight ridge around the center, but are otherwise smooth, even, and spherical in shape, suggesting low inhibition of radial expansion from the die.

FIG. 3 shows pictures of comparative food pieces (Variations 5 and 8 from Example 1) that have compositions outside of the described ranges, and exhibit a square or collared shape rather than a spherical shape, suggesting poor radial expansion from the die.

### DETAILED DESCRIPTION

Consumers continually expect an even greater variety of high protein foods that are suitable for different eating occasions. In addition, many consumers prefer to reduce carbohydrate intake. However, protein ingredients often suffer from bitter taste, astringency, and/or off-flavor/aroma, and have proven difficult to puff in the absence of carbohydrate-containing ingredients (e.g., starches) to produce a product that resembles a traditional ready-to-eat (RTE) grain-based breakfast cereal. The present application describes the discovery of high protein compositions containing little to no carbohydrate content that can be puffed into a low-density, high protein, RTE food piece having a pleasant, crunchy texture resembling traditional grain-based RTE breakfast cereal, and having a pleasant or neutral flavor, even in the absence of flavorants or off-flavor maskers.

A food piece provided herein is a high protein, low density, and ready-to-eat food piece. As used herein, the term “high protein” refers to a food piece that includes protein in an amount of at least 70% (e.g., at least 80%, at least 84%, or about 85-90%) by dry weight of the food piece. The term “low density” refers to a food piece that has a bulk density of about 75 to about 160 (e.g., about 90 to about 150, or about 90 to about 140) g/100 cubic inches as a result of direct expansion following extrusion from an extruder die. A low density food piece may also be referred to as “puffed.” As used herein, the term “ready-to-eat” (“RTE”) refers to a food that does not require further cooking or preparation to be suitable and safe for consumption. A food piece provided herein is typically also shelf stable at room temperature for at least 3 months (e.g., at least 6 months, or 8 months to 1 year) without significant negative impact on texture, structure, or flavor when stored in appropriate packaging. A food piece provided herein can also be suitably coated, or it can be used in other products, such as dry snacks, snack blends, cold-formed or baked snack bars or clusters.

A food piece provided herein includes a base protein blend that includes sodium caseinate (“Na Cas”) combined with a legume protein concentrate (“LPC”), a legume protein isolate (“LPI”), a milk protein concentrate (“MPC”), a milk protein isolate (“MPI”), or Na Cas combined with any combination of LPC, LPI, MPC, and MPI. Surprisingly, it was discovered that a food piece that includes a base protein blend in an amount of at least 60% (e.g., about 65% to 100%, or about 75% to 100%) by dry weight of protein ingredient content has a better texture and flavor than any one of Na Cas, MPI, MPC, LPC, or LPI alone. That is, a food piece provided herein has noticeably less pronounced dairy flavor than MPI, MPC, or Na Cas, alone and noticeably less pronounced legume flavor than LPC or LPI alone, resulting in a pleasant, or at least neutral flavor, even in the absence of flavorants or off-flavor maskers. Even if Na Cas is combined with one or both of MPI or MPC, in the absence of any legume protein source, it was discovered that dairy flavor was still reduced relative to any of Na Cas, MPI, or MPC alone. In addition, while it was found that none of Na Cas, MPI, MPC, legume protein concentrate, or legume protein isolate alone could be extruded to form a puffed food piece that produced a stable structure or suitable texture, the below-described combinations of protein ingredients produced both stable structure and suitable texture in a puffed piece.

As used herein, LPC and LPI can be derived from any appropriate legume, such as soybean, pea, chickpea, bean, lentil, or the like.

Sodium caseinate is included in a food piece in an amount of about 10% to about 60% (e.g., about 15% to about 55%, or about 25% to about 40%) by dry weight of protein ingredients. Na Cas extruded alone can result in extruder clogging, and including Na Cas in amounts of more than 50% by dry weight of the protein ingredients results in a texture that can be described as “tooth packing,” as well as increase the risk of producing products during extrusion with too much browning or that are burned or scorched. Less than 10% Na Cas by dry weight of protein ingredients results in food pieces that are denser and harder than desired.

LPC, LPI, MPC, MPI, or combination thereof is included in a food piece provided herein in an amount of about 20% to about 80% (e.g., about 25% to about 50%, or about 25% to about 40%) by dry weight of protein ingredients. In some embodiments a food piece provided herein can include LPC, LPI, or combination thereof in an amount of about 8% to about 50% (e.g., 20% to about 45%, or about 25% to about 35%) by dry weight of the protein ingredients and a MPC, MPI, or combination thereof in an amount of about 20% to about 50% (e.g., 25% to about 45%, or about 25% to about 35%) by dry weight of the protein ingredients.

LPC and LPI can contribute to a stable structure, desirable texture, and neutral or pleasing flavor when combined with Na Cas (with or without MPC and/or MPI), and can advantageously reduce cost of a food piece provided herein. LPC or LPI alone can be extruded, but some LPI and LPC were found to produce a dense, barrel-shaped pellet rather than puffing. In addition, increasing amounts of a LPI, especially soy protein isolate (“SPI”), can impact flavor, with around 33% SPI by dry weight of the protein ingredients starting to impact flavor. Although levels of LPI (e.g., SPI) can be included in amounts up to 80% by dry weight of the protein ingredients while still making an acceptable product, amounts of about 20% to about 40% by dry weight of the protein ingredients are more preferred to limit the impact on flavor. Similarly, combinations of LPI and LPC in increasing amounts can start to impact eating quality and puffing. For example, some embodiments of food pieces that contain a total soy protein ingredient content (i.e., SPI, SPC, or combinations thereof) in an amount of around 50-55% by dry weight of the protein ingredient content begin to exhibit dryness in the mouth, a mealy texture, and a beany flavor. As a result, it is preferred that total soy protein ingredient content be included at less than 60% by dry weight of the protein ingredients.

MPC and MPI can also contribute to a stable structure, desirable texture, including some crunchiness, and neutral or pleasing flavor of a food piece provided herein when combined with Na Cas (with or without LPC and/or LPI). MPC and MPI can be extruded alone, but they generally form dense pellets with little expansion and a glassy, sandy texture. In addition, amounts of MPC and/or MPI greater than 80% by dry weight of the protein ingredients results in a noticeable dairy flavor and reduced structural stability.

One or a combination of additional protein ingredients, such as calcium caseinate, acid casein, whey protein, wheat protein, can be included in a food piece provided herein in a total amount of up to 40% by dry weight of the protein ingredients. Calcium caseinate can be included in an amount of up to 30% (e.g., up to about 25%) by dry weight of protein ingredients. In some embodiments, additional protein ingredients other than calcium caseinate can be included in a total amount of up to 25% (up to 20%, or up to 18%) by dry weight of protein ingredients. More than 25% total additional protein ingredients (other than calcium caseinate) can cause effects such as reduced puffing, extrusion difficulty, and/or undesirable flavor. Calcium caseinate (“Ca Cas”) in amounts of up to 30% by dry weight of protein ingredients can contribute to a crunchy texture. Food pieces with a protein ingredient content comprising Na Cas+SPI and/or SPC+MPI at a ratio of about 1:1:1 or a protein ingredient content comprising Na Cas+SPC and/or SPI+MPI+Ca Cas at a ratio of about 1:1:1:1 produce particularly good results.

Protein ingredient content of some embodiments of a food piece provided herein that have particularly good texture, structure, and flavor, are provided in Table 1, with the percentages reflecting the amount by dry weight of the protein ingredients.

TABLE 1

| | | MPC, MPI, | LPC, LPI, | | | | |
|---|---|---|---|---|---|---|---|
| | | or any | or any | Ca | Wheat | Whey | Other |
| Embodiment | Na Cas | combination | combination | Cas | protein | protein | protein |
| 1 | 25-35% | 25-35% | 8-35% | 0-25% | 0-15% | 0-20% | 0-25% |
| 2 | 20-35% | 20-35% | 20-35% | 10-25% | 0-15% | 0-20% | 0-25% |
| 3 | 30-35% | 30-35% | 30-35% | 0% | 0% | 0% | 0% |
| 4 | 20-30% | 20-30% | 20-30% | 20-30% | 0% | 0% | 0% |

As used herein, the term “concentrate” when referring to a protein ingredient refers to an ingredient that includes at least 60% (e.g., at least 70%, or at least 80%) protein by dry weight. For example, a milk protein concentrate is typically about 80% to 90% protein by dry weight; a soy protein concentrate is typically about 65% to about 90% protein by dry weight. While commercially available pea protein ingredients that are labeled as “pea protein concentrate” can have a protein concentration of about 40% to about 60% by dry weight, as used herein, a pea protein ingredient having a protein content of at least 60% by dry weight is considered to be a concentrate suitable for use in a food piece. As used herein, the term “isolate” when referring to a protein ingredient refers to an ingredient that includes at least 75% (e.g., at least 80%, or at least 90%) protein by dry weight. For example, a milk protein isolate is typically about 90% to 94% protein by dry weight; a soy protein isolate is typically at least about 90% protein by dry weight; a pea protein isolate is typically about 75% to about 90% protein by dry weight.

In some embodiments, calcium carbonate (CaCO₃) can be included in an amount of up to 5% (e.g., about 0.1% to about 4%, or about 1%) by dry weight of a food piece. While good product can be made without any CaCO₃, CaCO₃ can contribute to a desired density, amounts of from about 1.5% to about 4% resulting in a larger quantity of smaller bubbles within the food piece to produce pieces that are on the denser end of the preferred range.

In some embodiments, oil (e.g., canola oil, corn oil, olive oil, soy oil, sunflower oil, and the like, or any combination thereof) in an amount of up to about 5% (e.g., 0.5% to about 5%, or 1% to about 2.5%) by dry weight of a food piece. An oil to be included in a composition can be selected based on, for example, nutritional profile, compatibility with extrusion process and/or equipment, texture and/or mouthfeel imparted to a food piece, and/or price. Generally, an oil can contribute to an improved flavor, especially when LPC and/or LPI are included at the higher end of their ranges. In addition, oil can increase tenderness and/or reduce glassiness in a food piece.

Additional optional ingredients can be included in an amount of up to 15% (e.g., up to 12%, or up to 10%) by dry weight of a food piece. For example, bulking agents, such as starches, flours, and/or fiber can be included to modify texture, add nutritional value, contribute to structure and/or reduce cost; gums and/or hydrocolloids can be included to prevent overnucleation during puffing, contribute to structure, and/or contribute to a desired texture; a sweetener (e.g., sugar, sugar alcohol, high potency sweetener, or the like) can be included to contribute to flavor/sweetness and/or structure or texture; colorants and/or flavorants to provide a desired appearance or flavor.

In some embodiments, a food piece provided herein can contain grain-based ingredients in an amount of less than 15% (e.g., less than 10%, or less than 5%) by dry weight of the food piece. As used herein, the term “grain-based” refers to an ingredient, such as a flour, maltodextrin, or starch, derived from grain, such as corn, wheat, rice, or oat. In some embodiments, a food piece provided herein can contain no grain-based ingredients.

In some embodiments, a food piece provided herein can have a total carbohydrate content of less than 5% (e.g., less than 3%) by dry weight.

In some embodiments, a food piece provided herein can contain no added carbohydrates. As used herein, the term “added carbohydrate” refers to a carbohydrate ingredient that is included in a food piece that is not a native component of a protein ingredient included in a food piece. For example, starches, fiber, lactose, or other sugars that may be natively found in MPI, MPC, Na Cas, Ca Cas, LPC, or LPI are not considered an added carbohydrate. However, starches from other sources (e.g., tapioca starch, corn starch, and the like), fibers from other sources (e.g., grain bran, non-digestive oligosaccharides, inulin, digestive resistant maltodextrins, soluble corn fiber, and the like), sugars from other sources (e.g., honey, table sugar, and the like) that are added to a food piece would be considered added carbohydrates.

A food piece provided herein can have a hardness of from about 80 kg to about 150 (e.g., about 80 to about 140, or about 85 to about 135) kg peak positive force, as measured by the Kramer Hardness test. As used herein, the Kramer Hardness test is performed using a TA-HD Plus texture analyzer (Texture Technologies Corp., Hamilton, MA) fitted with a 250 kg load cell and a 10 blade Kramer Shear Cell. Test speed is set to 2 mm/s, test distance is set to 82 mm (sufficient to pass the blades through the samples and into the bottom slots of the rig), and the test sequence is set to begin with a button trigger. Each sample includes 10 g (+/−one food piece or 0.1 g, whichever is smaller) of food pieces that are weighed into the Kramer Shear Cell. Maximum force is recorded using the texture analyzer software, and all measurements are performed at least twice, with an additional replicate being added if the coefficient of variation between the first two replicants is greater than 10%.

A food piece can optionally be coated with, e.g., a carbohydrate-based, sugar alcohol-based, or fat-based coating. However, the description above with respect to ingredient content does not take into account a coating. A coating can contribute to appearance, flavor, sweetness, color, texture, and the like. In some cases, a coating can contribute other attributes, such as increased bowl life for a RTE cereal. For example, a food piece provided herein can maintain crunchiness in milk for more than 2 minutes (e.g., 2 minutes to about 5 minutes, or about 3 minutes to about 4 minutes), while a coated food piece can maintain crunchiness in milk for a longer period of time (e.g., at least 5 minutes).

A method provided herein includes processing a composition described herein under extrusion conditions to produce a food piece. As used herein, the term “extrusion conditions” refers to subjecting a composition to heat, pressure, and shear in an extruder (e.g., single screw extruder, twin screw extruder, triple screw extruder, ring extruder, or the like). For example, a co-rotating, intermeshing, twin screw extruder can be used in a method provided herein. Manufacturers for co-rotating twin screw extruders include, for example, Coperion, Wenger, Clextral, Berstorff, APV, Baker Perkins, Buhler, and Leistritz.

A composition suitable for extrusion in a method provided herein includes a moisture content of from about 8% to about 20% (e.g., about 12% to about 18%) by weight of the composition. Composition moisture contents at the lower end of the range can produce food pieces with a lower density, while moisture at the higher end of the range can produce food pieces with a higher density.

A composition is typically made in a continuous fashion by feeding ingredients into an extruder during an extrusion process. In some embodiments, dry ingredients can be combined to produce a dry mix prior to being combined with water or other aqueous ingredients and, optionally, oil to produce a composition suitable for extrusion. In some embodiments, dry ingredients and a portion of water can be combined in a preconditioner prior to being fed into an extruder.

Extrusion conditions suitable for making a food piece provided herein generally include lower shear conditions, and lower temperature, than typically applied to a grain-based puffed RTE cereal piece. In the production of grain-based puffed RTE cereal pieces, reverse elements and/or high shear elements are generally used to ensure that the product is fully cooked, as mechanical heating from shear contributes to the cooking process. In addition, in the production of grain-based puffed RTE cereal pieces, reverse and/or high shear elements help to compress the material inside the extruder to ensure sufficient pressure to achieve puffing due to flash off of steam when the material leaves the die of the extruder. Typically, grain-based puffed RTE cereal pieces may be extruded in a twin screw extruder with 4 or more reverse and/or high shear elements (typically 5-7) to contribute shear and mechanical heating. Typically, extrusion conditions for grain-based RTE cereals include barrel temperatures that exceed 250° F. (e.g., typically more than 280° F.).

In contrast, food pieces provided herein should be extruded under low shear conditions, with fewer reverse and/or high shear elements to prevent over shearing, which results in burning the ingredients and little to no puffing. Reverse and/or high shear elements may still contribute to ensuring that a food piece provided herein is fully cooked and suitable to be ready-to-eat, and to provide sufficient compression and pressure to achieve puffing. However, much lower temperatures (e.g., barrel temperature 260° F. or lower) than typically used for grain-based RTE cereal can surprisingly achieve puffing of a composition described herein to produce a low density, high protein RTE food piece. For example, in a 7 barrel, 42 mm twin screw extruder being run at about 300 rpm, with a feed rate of 1000 g/minute dry feed and a barrel temp of about 180° F., 1-3 reverse elements or high shear elements (e.g., 2 reverse or high shear elements) works well.

In some embodiments, extrusion conditions can comprise a barrel temperature of about 160° F. to about 260° F. (e.g., from about 170° F. to about 250° F., or from about 180° F. to about 245° F.). As used herein, the term “barrel temperature” refers to the maximum temperature of a heated barrel of an extruder. In some embodiments, extrusion conditions can comprise a die temperature of about 200° F. to about 280° F. (e.g., from about 220° F. to about 280° F., or from about 250° F. to about 270° F.). As used herein, the term “die temperature” refers to the maximum temperature of a composition inside a die assembly of an extruder. In some embodiments, extrusion conditions can comprise a die pressure of about 550 psi to about 1800 psi (e.g., from about 600 psi to about 1500 psi, or about 800 psi to about 1400 psi). As used herein, the term “die pressure” refers to the maximum pressure measured in the die just before the die exit. In some embodiments, extrusion conditions can comprise a specific mechanical energy (SME) of about 80 W*h/kg to about 140 w*h/kg (e.g., about 85 to about 125 W*h/kg). In some embodiments, extrusion conditions can comprise a screw speed of about 220 to about 360 (e.g., about 250 to about 340, or about 280 to about 320) rpm. In some embodiments, e.g., using a Buhler 42 mm twin screw extruder, extrusion conditions can comprise a dry feed rate of about 800 to about 1200 (e.g., about 1000) g/minute, with a water feed rate sufficient to achieve the desired moisture content of a composition (e.g., about 8% to about 20%), and optional oil feed rate sufficient to achieve the desired oil content in the food piece (e.g., up to 5% by dry weight).

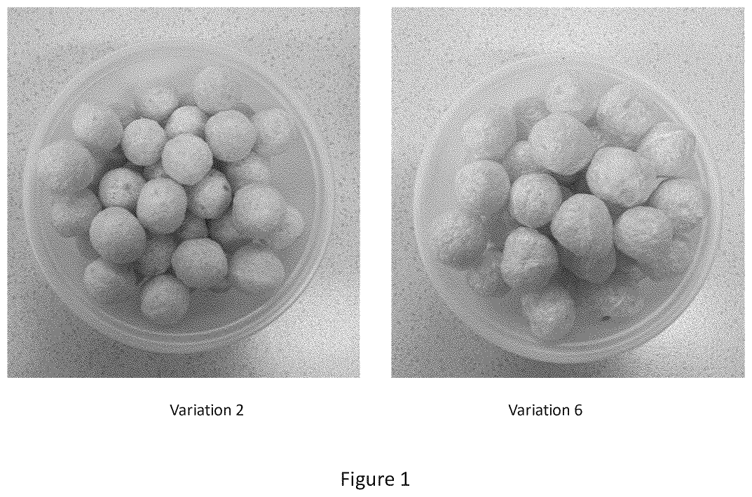

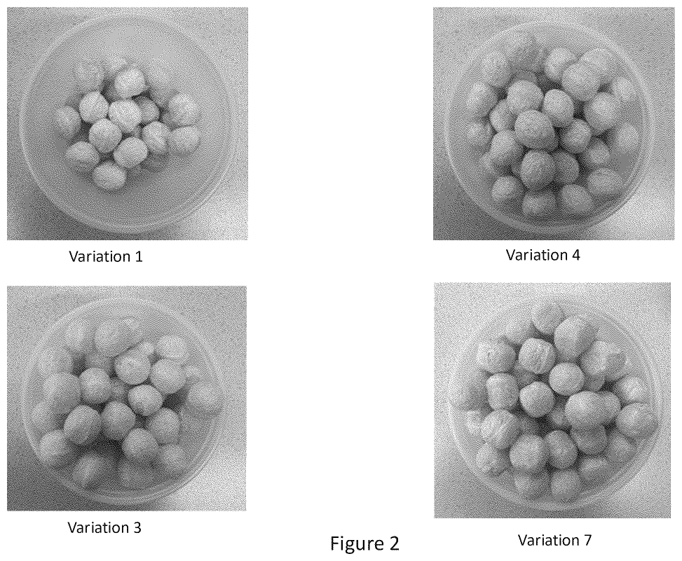

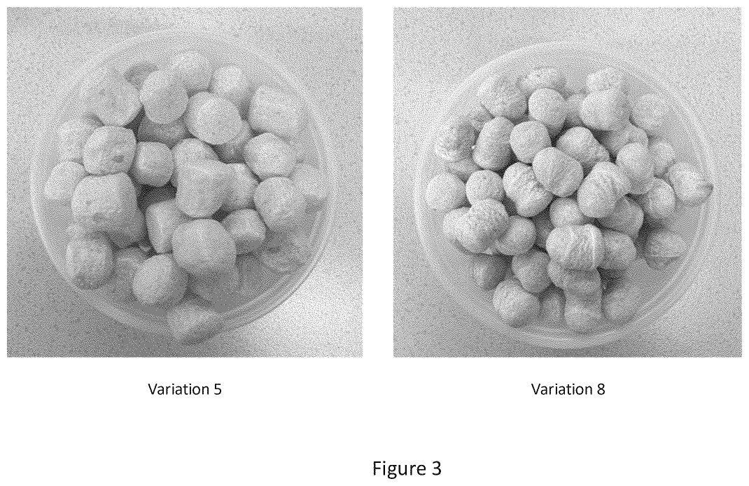

A method provided herein includes forming extruded food pieces from a composition by extruding the composition through a die opening whereby the composition is directly expanded (puffed) upon exiting the die. A die opening can be any appropriate geometry, such as circular opening, a slit, or an irregular opening, and if multiple openings are included in an extruder die assembly, each opening need not have the same geometry. In some embodiments, extruded pieces with a spherical shape can be produced using a die that has a relatively long land length (e.g., 0.1 to about 0.5 inches, or about 0.4 inches) and a relatively small circular opening (e.g., less than 0.5 inches in diameter, about 0.1 to about 0.4 inches in diameter, or about 0.1 to about 0.2 inches in diameter). In some embodiments, a food piece can be achieved with a smooth, even, and spherical shape, due to good radial expansion from the die. FIG. 1 shows embodiments that are particularly smooth, even, and spherical in shape, suggesting little to no inhibition of radial expansion from the die. FIG. 2 shows embodiments that have a slight ridge around the center, but are otherwise smooth, even, and spherical in shape, suggesting low inhibition of radial expansion from the die. FIG. 3, in contrast, shows food pieces that have compositions outside of the described ranges, and exhibit a square or collared shape rather than a spherical shape, suggesting poor radial expansion from the die.

In some embodiments, food pieces can have a sectional expansion index (SEI) of from about 6 to about 10 (e.g., about 7 to about 9, or about 7.5 to about 8.5). As used herein, SEI is measured by measuring food pieces laterally using a caliper, and is expressed as the ratio of the cross sectional area of the extrudate to the area of the die opening. SEI is obtained from a mean of 25 random samples.

In some embodiments, extruded food pieces can have average diameter of from about 8 mm to about 20 mm (e.g., from about 10 mm to about 15 mm). However, the size of a food piece can be adjusted for the desired use of the food piece or to provide a manufacturing advantage. For example, the size of a food piece can be adjusted to provide a desired size for eating as a stand-alone RTE breakfast cereal or snack, or for use as a component in a snack bar or snack mix. In another example, the size of a food piece can be adjusted to result in a desired drying time during manufacturing. Piece size can be adjusted using known methods, such as die size and/or die shape selection, rate of extrusion, and/or cutter speed. For example, cutter speed can be reduced to form elongated puffed pieces, such as pieces resembling churros or snack straws or sticks.

In some embodiments, a food piece can be dried to a moisture content of less than 8% (e.g., about 1% to about 7%, less than 6%, or about 2% to about 4%) to produce dried food pieces. Drying can be performed using any suitable method and equipment, such as a belt dryer. In some embodiments, drying can be performed at a temperature of about 200° F. to about 260° F. (e.g., about 210° F. to about 250° F., or about 220° F. to about 240° F.).

In some embodiments, food pieces provided herein can be packaged and sold as a food product without any other components. Such packaged food pieces can be intended to be eaten as a food product alone or in combination with other food products. For example, food pieces can be packaged and sold as a stand-alone snack, alone or as part of a RTE breakfast cereal. In some embodiments, a food piece can be adhered with one or more edible components, such as another food piece, nut pieces, fresh or dried fruit pieces, seeds, coconut, grain, and the like, to form a cluster or bar. A food piece and one or more edible components can be adhered to each other using any appropriate method and ingredients (e.g., edible binders and the like). For example, a cluster can be produced using a combination of a food piece and rolled oats adhered using a honey-based binder or slurry. Clusters can be provided as a food product alone or as part of a food product, such as a snack mix, ready to eat cereal, or oatmeal mix.

It is to be understood that food pieces provided herein can be used for either sweet or savory applications in food. Food pieces disclosed herein can provide a benefit of being a high protein stand-alone food product or provide added protein in combination with other components in food products while also providing an improved texture and flavor over other known high protein pieces.

### EXAMPLES

### Example 1

Food pieces were made according to the following procedure. Ingredients by total weight percentage are in Table 2. The dry ingredients for each variation were mixed in a single batch and fed into a Buhler 42 twin screw extruder fit with a single round 0.159 inch diameter die. Actual temperatures within each barrel varied by up to 10° F. from the set point. The dry ingredients for each variation were fed at a rate of 1000 g/min. Sodium caseinate (Na Cas) had a protein content of about 90% by dry weight. Soy protein isolate (SPI) had a protein content of about 90% by dry weight. Soy protein concentrate (SPC) had a protein content of about 72% by dry weight. Milk protein isolate (MPI) had a protein content of about 90% by dry weight and a lactose content of about 1%. Calcium caseinate (Ca Cas) had a protein content of about 94% by dry weight. Wheat protein isolate (WPI) had a protein content of about 90% by dry weight. Canola oil was used as the oil. Table 2 also scores each variation as being unacceptable (score of 1) or acceptable, with a score of 2 being least preferred and a score of 4 being most preferred. Scores were based on eating experience (texture, flavor, astringency).

Variation 1: Barrel 1 was at ambient temperature, barrel 2 was set at 110° F., barrel 3 was set at 180° F., barrel 4 was set at 220° F., barrels 5 and 6 were set at 230° F., and barrel 7 was set at 200° F. The die temperature at the extruder exit was about 242° F. Water and steam were added at a rate of 180 g/min. The product was processed at a screw speed of 425 RPM (revolutions per minute) using a screw configuration containing 2 reverse elements. The resulting torque on the system was 21.4%, yielding an SME of 82 W-Hr/Kg. With a die pressure of 744 psi, the ropes were face cut into spherical puffs with a resulting product wet bulk density of 102 g/100 in³. Tray of product samples were dried in a forced air dryer for 8 minutes at 230° F., resulting in a final product moisture of 2.4%. The dried product yielded a bulk density of 108 g/100 in³ and a hardness value of 92 kg peak positive force as measured by the Kramer test.

Variation 1 exhibited a hardness value of about 92 kg peak positive force compared to 127 kg peak positive force for an uncoated Kix™ brand puffed corn-based RTE cereal piece. Although the hardness of Variation 1 was lower than uncoated Kix™ brand puffed corn-based RTE cereal piece, texture and eating quality were similar.

The protein content of Variation 1 was calculated to be about 90% by dry weight.

Variation 2: Barrel 1 was at ambient temperature, barrel 2 was set at 105° F., barrel 3 was set at 180° F., barrels 4, 5, and 6 were set at 230° F., and barrel 7 was set at 200° F. The die temperature at the extruder exit was 248° F. Water was added at the second barrel section at a rate of 200 g/min and canola oil was added at the end of the second barrel section at a rate of 25 g/min. The product was processed at a screw speed of 300 RPM (revolutions per minute) using a screw configuration containing 2 reverse elements. The resulting torque on the system was 35%, yielding an SME of 88 W-Hr/Kg. With a die pressure of 1192 psi, the ropes were face cut into spherical puffs with a resulting product wet bulk density of 128 g/100 in³. Tray of product samples were dried in a forced air dryer for 18 minutes at 230° F., resulting in a final product moisture of 1.9%. The dried product yielded a bulk density of 133 g/100 in³ and a hardness value of 87 kg peak positive force as measured by the Kramer test.

The final dried food piece for Variation 2 contained about 88% protein, about 3% fat, 0% carbohydrates, 1.9% moisture, and the remainder ash.

Variation 3: Barrel 1 was at ambient temperature, barrel 2 was set at 105° F., barrel 3 was set at 180° F., barrels 4, 5, and 6 were set at 230° F., and barrel 7 was set at 200° F. The die temperature at the extruder exit was 261° F. Water was added at the second barrel section at a rate of 200 g/min, while canola oil was not added to this variation. The product was processed at a screw speed of 350 RPM (revolutions per minute) using a screw configuration containing 2 reverse elements. The resulting torque on the system was 32%, yielding an SME of 93 W-Hr/Kg. With a die pressure of 1301 psi, the ropes were face cut into spherical puffs with a resulting product wet bulk density of 114 g/100 in³. Tray of product samples were dried in a forced air dryer for 10 minutes at 230° F., resulting in a final product moisture of 2.6%. The dried product yielded a bulk density of 122 g/100 in³ and a hardness value of 114 kg peak positive force as measured by the Kramer test.

The final dried food piece for variation 3 was measured to contain about 89.5% protein by dry weight.

Variation 4: Barrel 1 was at ambient temperature, barrel 2 was set at 100° F., barrel 3 was set at 180° F., barrel 4 was set at 225° F., barrels 5 and 6 were set at 230° F., and barrel 7 was set at 200° F. The die temperature at the extruder exit was 260° F. Water was added at the second barrel section at a rate of 180 g/min, while canola oil was not added to this variation. The product was processed at a screw speed of 300 RPM (revolutions per minute) using a screw configuration containing 2 reverse elements. The resulting torque on the system was 36%, yielding an SME of 96 W-Hr/Kg. With a die pressure of 1160 psi, the ropes were face cut into spherical puffs with a resulting product wet bulk density of 118 g/100 in³. Tray of product samples were dried in a forced air dryer for 9 minutes at 230° F., resulting in a final product moisture of 2.4%. The dried product yielded a bulk density of 117 g/100 in³ and a hardness value of 100 kg peak positive force as measured by the Kramer test.

The final dried food piece for variation 4 was calculated to contain about 86% protein by dry weight.

Variation 5: Barrel 1 was at ambient temperature, barrel 2 was set at 100° F., barrel 3 was set at 180° F., barrel 4 was set at 225° F., barrels 5 and 6 were set at 230° F., and barrel 7 was set at 200° F. The die temperature at the extruder exit was 266° F. Water was added at the second barrel section at a rate of 200 g/min, while canola oil was not added to this variation. The product was processed at a screw speed of 300 RPM (revolutions per minute) using a screw configuration containing 2 reverse elements. The resulting torque on the system was 37%, yielding an SME of 98 W-Hr/Kg. With a die pressure of 1400 psi, the ropes were face cut into spherical puffs with a resulting product wet bulk density of 128 g/100 in³. Tray of product samples were dried in a forced air dryer for 8 minutes at 230° F., resulting in a final product moisture of 2.6%. The dried product yielded a bulk density of 136 g/100 in³ and a hardness value of 119 kg peak positive force as measured by the Kramer test.

The final dried food piece for variation 5 was calculated to contain about 91% protein by dry weight.

Variation 6: Barrel 1 was at ambient temperature, barrel 2 was set at 100° F., barrel 3 was set at 180° F., barrel 4 was set at 225° F., barrels 5 and 6 were set at 230° F., and barrel 7 was set at 200° F. The die temperature at the extruder exit was 280° F. Water was added at the second barrel section at a rate of 180 g/min, while canola oil was not added to this variation. The product was processed at a screw speed of 340 RPM (revolutions per minute) using a screw configuration containing 2 reverse elements. The resulting torque on the system was 38%, yielding an SME of 120 W-Hr/Kg. With a die pressure of 1453 psi, the ropes were face cut into spherical puffs with a resulting product wet bulk density of 97 g/100 in³. Tray of product samples were dried in a forced air dryer for 8 minutes at 230° F., resulting in a final product moisture of 3.8%. The dried product yielded a bulk density of 99 g/100 in³ and a hardness value of 57 kg peak positive force as measured by the Kramer test.

The final dried food piece for variation 6 calculated to contain about 91% protein by dry weight.

Variation 7: Barrel 1 was at ambient temperature, barrel 2 was set at 100° F., barrel 3 was set at 180° F., barrel 4 was set at 225° F., barrels 5 and 6 were set at 230° F., and barrel 7 was set at 200° F. The die temperature at the extruder exit was 280° F. Water was added at the second barrel section at a rate of 168 g/min, and canola oil was added at the end of the second barrel section at a rate of 25 g/min. The product was processed at a screw speed of 300 RPM (revolutions per minute) using a screw configuration containing 2 reverse elements. The resulting torque on the system was 38%, yielding an SME of 95 W-Hr/Kg. With a die pressure of 1754 psi, the ropes were face cut into spherical puffs with a resulting product wet bulk density of 145 g/100 in³. Tray of product samples were dried in a forced air dryer for 17 minutes at 230° F., resulting in a final product moisture of 2.4%. The dried product yielded a bulk density of 145 g/100 in³ and a hardness value of 121 kg peak positive force as measured by the Kramer test.

The final dried food piece for variation 7 was calculated to contain about 84% protein by dry weight.

Variation 8: Barrel 1 was at ambient temperature, barrel 2 was set at 100° F., barrel 3 was set at 180° F., barrel 4 was set at 225° F., barrels 5 and 6 were set at 230° F., and barrel 7 was set at 200° F. The die temperature at the extruder exit was 270° F. Water was added at the second barrel section at a rate of 215 g/min, and canola oil was added at the end of the second barrel section at a rate of 25 g/min. The product was processed at a screw speed of 300 RPM (revolutions per minute) using a screw configuration containing 2 reverse elements. The resulting torque on the system was 47%, yielding an SME of 116 W-Hr/Kg. With a die pressure of 1910 psi, the ropes were face cut into spherical puffs with a resulting product wet bulk density of 219 g/100 in³. Tray of product samples were dried in a forced air dryer for 17 minutes at 230° F., resulting in a final product moisture of 1.8%. The dried product yielded a bulk density of 238 g/100 in³ and a hardness value of 235 kg peak positive force as measured by the Kramer test.

The final dried food piece for variation 8 was calculated to contain about 82% protein by dry weight.

TABLE 2

| | Na | | | | Ca | | | | | |
|---|---|---|---|---|---|---|---|---|---|---|
| Variation | Cas | SPI | SPC | MPI | Cas | WPI | Water | Oil | CaCO₃ | Score |
| 1 | 49% | 33% | 0% | 0% | 0% | 0% | 16.7% | 0% | 0.8% | 2 |
| 2 | 27% | 27% | 0% | 27% | 0% | 0% | 16.4% | 2% | 0.9% | 4 |
| 3 | 21% | 21% | 0% | 21% | 21% | 0% | 16.7% | 0% | 0.9% | 3 |
| 4 | 37% | 19% | 0% | 19% | 0% | 8.5% | 15.3% | 0% | 1.5% | 3 |
| 5 | 21% | 21% | 0% | 0% | 21% | 21% | 16.7% | 0% | 0.9% | 1 |
| 6 | 21% | 21% | 0% | 21% | 21% | 0% | 15.2% | 0% | 0% | 3 |
| 7 | 17% | 22.5% | 22.5% | 22% | 0% | 0% | 14% | 2% | 0.1% | 2 |
| 8 | 9% | 5.5% | 21.5% | 45% | 0% | 0% | 17.3% | 2% | 0.1% | 1 |

The implementations described above and other implementations are within the scope of the following claims. One skilled in the art will appreciate that the present disclosure can be practiced with embodiments other than those disclosed. The disclosed embodiments are presented for purposes of illustration and not limitation.

1. A ready-to-eat food piece having a bulk density of about 75 to about 160 g/100 cubic inches, a protein content of at least 70% by dry weight of the food piece and a moisture content of about 1% to about 7%, and comprising protein ingredients, the protein ingredients including a base protein blend that comprises at least 60% by dry weight of the protein ingredients, the base protein blend consisting of:
a. sodium caseinate (Na Cas) in an amount of about 10% to about 60% by dry weight of the protein ingredients; and
b. legume protein isolate (LPI), legume protein concentrate (LPC), milk protein isolate (MPI), milk protein concentrate (MPC), or a combination thereof in an amount of about 20% to about 80% by dry weight of the protein ingredients.

2. The food piece of claim 1, wherein soy protein isolate (SPI) or milk protein isolate (MPI) is included in an amount of up to 55% by dry weight of the protein ingredients.

3. The food piece of claim 1, wherein the food piece comprises:
a. Na Cas in an amount of 10% to about 40% by dry weight of the protein ingredients,
b. MPI, MPC, or a combination thereof in an amount of 20% to 50% by dry weight of the protein ingredients, and
c. SPI, SPC, calcium caseinate (Ca Cas), or a combination thereof in an amount of about 20% to 50% by dry weight of the protein ingredients.

4. The food piece of claim 3, wherein the food piece comprises:
a. Na Cas in an amount of 10% to about 40% by dry weight of the protein ingredients,
b. MPI, MPC, or a combination thereof in an amount of 25% to 45% by dry weight of the protein ingredients, and
c. SPI, SPC, Ca Cas, or a combination thereof in an amount of about 25% to 45% by dry weight of the protein ingredients.

5. The food piece of claim 1, wherein the food piece comprises calcium carbonate in an amount of about 0.1% to 4% by dry weight of the food piece.

6. The food piece of claim 1, wherein the food piece comprises canola oil or corn oil in an amount of about 0.1% to about 5% by dry weight of the food piece.

7. The food piece of claim 1, wherein the food piece comprises one or a combination of additional protein ingredients in an amount of up to 40% by dry weight of the protein ingredients.

8. The food piece of claim 1, wherein the food piece comprises an additional ingredient in an amount of up to 15% by dry weight of the food piece.

9. The food piece of claim 1, wherein ingredients derived from grains are included in an amount of less than 15% by dry weight.

10. The food piece of claim 1, wherein the food piece contains no ingredients derived from grains.

11. The food piece of claim 1, wherein the food piece contains less than 5% by dry weight carbohydrate.

12. The food piece of claim 11, wherein the food piece contains no added carbohydrates.

13. A method of making a ready-to-eat food piece having a bulk density of about 75 to about 160 g/100 cubic inches and a protein content of at least 70% by dry weight of the food piece, the method comprising:
a. combining ingredients under extrusion conditions to make a composition having a protein content of at least 70% by dry weight of the composition, the ingredients including:
1. protein ingredients including a base protein blend comprising at least 60% by dry weight of the protein ingredients, the base protein blend consisting of:
i. sodium caseinate in an amount of about 10% to about 60% by dry weight of the protein ingredients; and
ii. legume protein isolate, legume protein concentrate, milk protein isolate, milk protein concentrate, or any combination thereof in an amount of about 20% to about 80% by dry weight of the protein ingredients; and
2. water in an amount of about 8% to about 20% by weight of the composition;
the extrusion conditions comprising low shear, and a barrel temperature of about 160° F. to about 260° F.;
b. forming and puffing the composition by directing the composition through a die opening to make a puffed piece; and
c. drying the puffed piece to a moisture content of about 1% to about 7% to produce the food piece.

14. The method of claim 13, wherein extrusion conditions comprise a barrel temperature of about 170° F. to about 250° F.

15. The method of claim 13, wherein extrusion conditions comprise a twin screw extruder with 2 reverse or high shear elements.

16. The method of claim 13, wherein extrusion conditions comprise a die pressure of about 550 psi to about 1800 psi.

17. The method of claim 16, wherein the die pressure is from about 800 psi to about 1500 psi.

18. The method of claim 13, wherein extrusion conditions comprise specific mechanical energy (SME) of about 80 W*h/kg to about 140 W*h/kg.

19. The method of claim 18, wherein the SME is from about 85 W*h/kg to about 125 W*h/kg.

20. The method of claim 13, wherein extrusion conditions comprise a die temperature of about 200° F. to about 280° F.

21. The method of claim 20, wherein the die temperature is from about 220° F. to about 280° F.
